(19) United States
(12) Patent Application Publication
(10) Pub. No.: US 2018/0363687 A1
(43) Pub. Date: Dec. 20, 2018

(54) Clip System and Clips for Affixing Insulation

(71) Applicant: Sunron International LLC, Henderson, KY (US)

(72) Inventors: Darrell Edward Littrell, Henderson, KY (US); Luke Thomas Wallis, Newburgh, IN (US); Steven D. Hagan, Corydon, IN (US); Jarrod L. McGraw, Corydon, KY (US); Anthony C. Schauberger, Boonville, IN (US)

(21) Appl. No.: 15/622,847

(22) Filed: Jun. 14, 2017

(51) Int. Cl. F16B 5/06; F16B 2/22; E04B 1/41; E04B 1/76

(52) U.S. Cl. CPC F16B 5/0642; F16B 2/22; E04B 1/7629; E04B 1/40; F16B 5/0635

(57) ABSTRACT

This disclosure relates to a clip system and clips for affixing insulation. Clips are taught which include a base, a spacer extending therefrom, and a head attached to the spacer opposite the base. The head of a T-clip has a laterally extending portion in a parallel relationship with the base. The head of an A-clip has a generally arrow head shaped cross section. At least one T-clip and at least one A-clip comprise the clip system. The clips are preferably used to affix insulation to the exterior of a wall using two-sided tape attached to the base rear of each clip.

### FIELD OF THE INVENTION

This disclosure relates to a clip system and clips for affixing insulation, preferably to the exterior of a concrete or concrete block wall, which may or may not have a waterproof coating applied thereto, the wall with the insulation affixed to have a fill placed there against. The clip system includes at least two types of clips, one which is used where sheets of insulation will abut generally in the same plane, and a different one which is used internal to a sheet of insulation or near to a sheet edge where there is not another sheet abutting generally in the same plane. Clips include a base, a spacer extending therefrom, and a head attached to the spacer opposite the base. The head of a T-clip has a laterally extending portion in a parallel relationship with the base. The head of an A-clip has a generally arrow head shaped cross section. The clips are preferably used to affix insulation to a wall using two-sided tape attached to the base rear of each clip.

### BACKGROUND OF THE INVENTION

Previous means for attaching insulation to the exterior of a concrete wall generally included having a component to pierce both the insulation and into the wall to “nail” the insulation onto the wall. If the wall had a waterproof coating applied, nailing the insulation to the wall could compromise the waterproofing capabilities as well as potentially compromise the concrete where it received a “nail.” The clips and clip system of the present invention permit sheets of insulation to be affixed to a wall using, preferably, a two-sided tape attached to each clip's base rear surface and to the wall.

### SUMMARY

This disclosure relates to a clip system and clips for affixing insulation, preferably to the exterior of a concrete or concrete block wall, which may or may not have a waterproof coating applied thereto, the wall with the insulation affixed to have a fill placed there against. By using clips with two-sided tape on their base rear surfaces, the wall to which the clips are affixed is not compromised.

Embodiments of the present invention relate to a clip system for affixing insulation to a wall comprising at least one T-clip having a base with a base front surface and an opposed base rear surface; a spacer extending from the base, away from the base front surface and generally transverse thereto, the spacer having a bottom facing side and an opposed top facing side, the spacer receiving a head thereon opposed from the base, the head having a laterally extending portion with a head front surface and a head rear surface, where the head rear surface is in a parallel relationship with the base front surface; and, at least one A-clip having a base with a base front surface and an opposed base rear surface; a spacer extending from the base, away from the base front surface and generally transverse thereto, the spacer having a bottom facing side and an opposed top facing side, the spacer receiving a head thereon opposed from the base, the head having a head front surface with a rearward sloping surface and an underneath rear surface.

Further, preferably, the T-clip head rear surface, the spacer bottom facing side, and the base form a bottom insulation receiving slot and the T-clip head rear surface, the spacer top facing side, and the base form a top insulation receiving slot. The T-clip head rear surface is spaced at least one inch away from the base front surface, or, alternatively, at least two inches away. The A-clip head has a generally arrow head shaped cross section. Further, the A-clip spacer preferably removes the head from the base a distance of at least one inch. For both the T-clips and the A-clips, each most preferably have a two-sided tape attached to their base rear surface.

Other embodiments include a clip for affixing insulation to a wall, comprising a base with a base front surface and an opposed base rear surface; a spacer extending from the base, away from the base front surface and generally transverse thereto, the spacer having a bottom facing side and an opposed top facing side, the spacer receiving a head thereon opposed from the base. In one embodiment, the T-clip embodiment, the head has a laterally extending portion with a head front surface and a head rear surface, where the head rear surface is in a parallel relationship with the base front surface. Preferably, the head rear surface, the spacer bottom facing side, and the base can form a bottom insulation receiving slot and the head rear surface, the spacer top facing side, and the base can form a top insulation receiving slot. With this T-clip, the head rear surface can be spaced at least one inch away from the base front surface, or, alternatively, at least two inches away, or a different distance if a different thickness of the insulation to be affixed. In another embodiment, the A-clip embodiment, the head has a head front surface with a rearward sloping surface and an underneath rear surface. Preferably, the head has an arrowhead or arrow shaped cross-section. More preferably, the spacer removes the head from the base a distance of at least one inch, and it is believed that this distance will permit use of this A-clip to affix insulation of any thickness. With either the T-clip or the A-clip, it is most preferable that each have a two-sided tape attached to their base rear surface, which will be used to adhere the clip to the wall, rather than previous methods of “nailing” insulation to a wall, possibly compromising any waterproof coating or damaging the wall.

This summary is provided to introduce a selection of the concepts that are described in further detail in the detailed description and drawings contained herein. This summary is not intended to identify any primary or essential features of the claimed subject matter. Some or all of the described features may be present in the corresponding independent or dependent claims, but should not be construed to be a limitation unless expressly recited in a particular claim. Each embodiment described herein is not necessarily intended to address every object described herein, and each embodiment does not necessarily include each feature described. Other forms, embodiments, objects, advantages, benefits, features, and aspects of the present invention will become apparent to one of skill in the art from the detailed description and drawings contained herein. Moreover, the various apparatuses and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

A better understanding of the present invention will be had upon reference to the following description in conjunction with the accompanying drawings.

FIG. 1 is a perspective view of a first clip of the invention from the front, bottom, left side;

FIG. 2 is a perspective view of the first clip of FIG. 1 from the rear, top, right side;

FIG. 3 is left side view of the first clip of FIG. 1, the right side view being a mirror image thereof;

FIG. 4 is a front plan view of the first clip of FIG. 1;

FIG. 5 is a bottom plan view of the first clip of FIG. 1, the top plan view being a mirror image thereof;

FIG. 6 is a rear plan view of the first clip of FIG. 1;

FIG. 7 is a perspective view of the first clip of FIG. 1 from the rear, top, right side, the base rear surface having two-sided tape attached thereto;

FIG. 8 is rear plan view of the first clip of FIG. 7, the base rear surface having two-sided tape attached thereto;

FIG. 9 is a perspective view of a second clip of the invention from the front, bottom, left side;

FIG. 10 is a perspective view of the second clip of FIG. 9 from the rear, top, right side;

FIG. 11 is left side view of the second clip of FIG. 9, the right side view being a mirror image thereof;

FIG. 12 is a front plan view of the second clip of FIG. 9;

FIG. 13 is a bottom plan view of the second clip of FIG. 9, the top plan view being a mirror image thereof;

FIG. 14 is a rear plan view of the second clip of FIG. 9;

FIG. 15 is a perspective view of the second clip of FIG. 9 from the rear, top, right side, the base rear surface having two-sided tape attached thereto;

FIG. 16 is rear plan view of the first clip of FIG. 15, the base rear surface having two-sided tape attached thereto;

FIG. 17 is a perspective view of a third clip of the invention from the front, bottom, left side;

FIG. 18 is a perspective view of the third clip of FIG. 17 from the rear, top, right side;

FIG. 19 is left side view of the third clip of FIG. 17, the right side view being a mirror image thereof;

FIG. 20 is a front plan view of the third clip of FIG. 17;

FIG. 21 is a bottom plan view of the third clip of FIG. 17, the top plan view being a mirror image thereof;

FIG. 22 is a rear plan view of the third clip of FIG. 17;

FIG. 23 is a perspective view of the third clip of FIG. 17 from the rear, top, right side, the base rear surface having two-sided tape attached thereto;

FIG. 24 is rear plan view of the third clip of FIG. 23, the base rear surface having two-sided tape attached thereto; and,

FIG. 25 is perspective view demonstrating the affixing of insulation to a wall using clips and the clip system of the instant invention.

### DETAILED DESCRIPTION OF THE PREFERRED EMBODIMENTS

For the purposes of promoting an understanding of the principles of the invention, reference will now be made to selected embodiments illustrated in the drawings and specific language will be used to describe the same. It will nevertheless be understood that no limitation of the scope of the invention is thereby intended; any alterations and further modifications of the described or illustrated embodiments, and any further applications of the principles of the invention as illustrated herein are contemplated as would normally occur to one skilled in the art to which the invention relates. At least one embodiment of the invention is shown in great detail, although it will be apparent to those skilled in the relevant art that some features or some combinations of features may not be shown for the sake of clarity.

Any reference to “invention” within this document is a reference to an embodiment of a family of inventions, with no single embodiment including features that are necessarily included in all embodiments, unless otherwise stated. Furthermore, although there may be references to “advantages” provided by some embodiments of the present invention, other embodiments may not include those same advantages, or may include different advantages. Any advantages described herein are not to be construed as limiting to any of the claims.

Specific quantities (spatial dimensions, dimensionless parameters, etc.) may be used explicitly or implicitly herein, such specific quantities are presented as examples only and are approximate values unless otherwise indicated. Discussions pertaining to specific compositions of matter, if present, are presented as examples only and do not limit the applicability of other compositions of matter, especially other compositions of matter with similar properties, unless otherwise indicated.

The following legend relates to the numbers shown in the drawings: 2—wall; 4—1 inch insulation, 6—insulation edge; 10, 100, 200—clip; 11—top; 12—bottom; 13—left side; 14—right side; 15—front; 16—rear; 20—base; 22—base front surface; 24—base rear surface; 26—opening in base; 30, 130, 230—spacer; 32, 132, 232—spacer bottom facing side; 34, 134, 234—spacer top facing side; 40, 240—head; 42—head laterally extending portion; 44—head front surface; 46—head read surface; 241—head front surface; 243—head rearward sloping surface; 245—head rear surface; 50 two-sided tape; 52—base rear surface engaging side of tape; 54—wall engaging side of tape; 60—top slot to receive insulation; and, 62—bottom slot to receive insulation. Clips 10, 100, and 200 are identified in the figures as each having a top 11, bottom 12, left side 13, right side 14, front 15, and rear 16. Those numbers are used for ease of understanding of the figures and this description. Clips 10, 100, and 200 are also preferably injection molded. The base 20 of each clip 10, 100, or 200 is shown with openings 26 therethrough which allow for each clip to be injection molded.

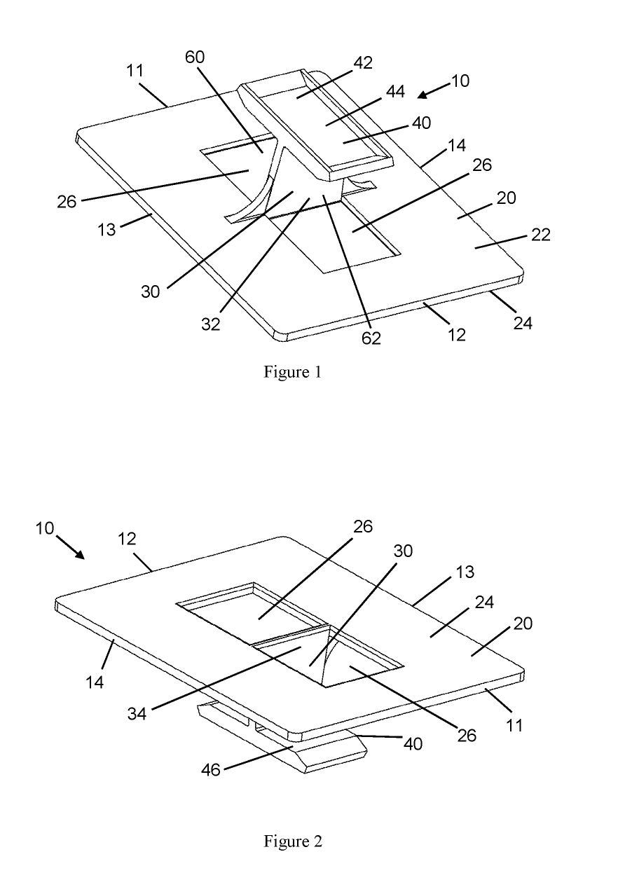

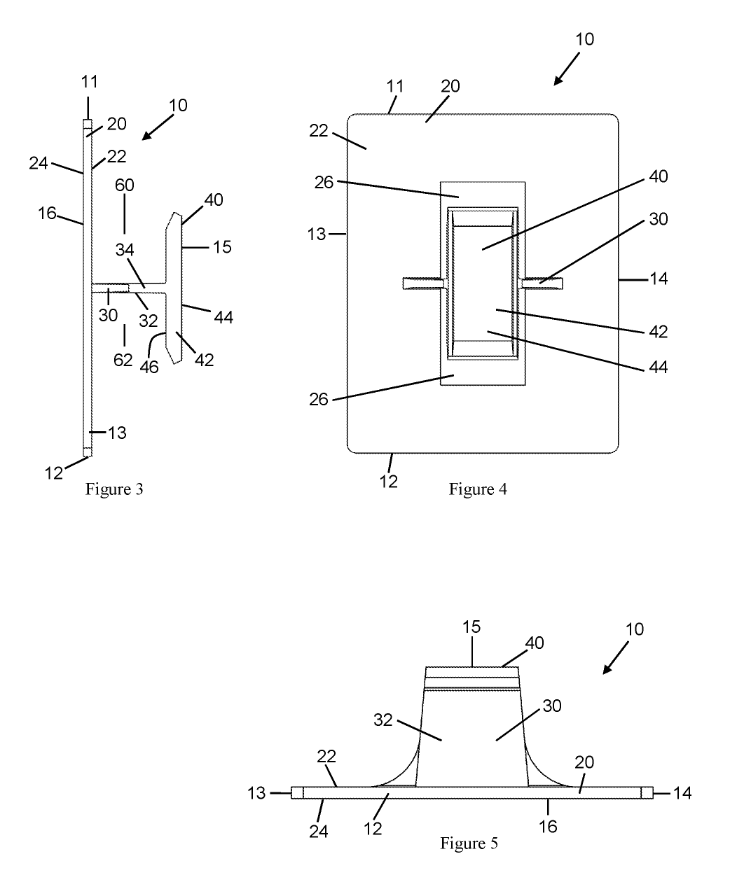

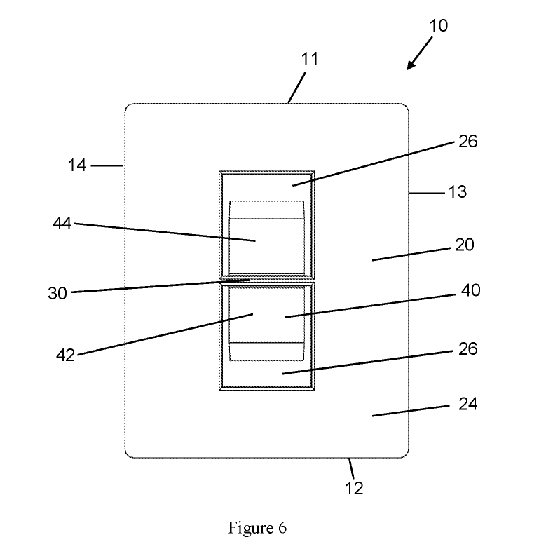

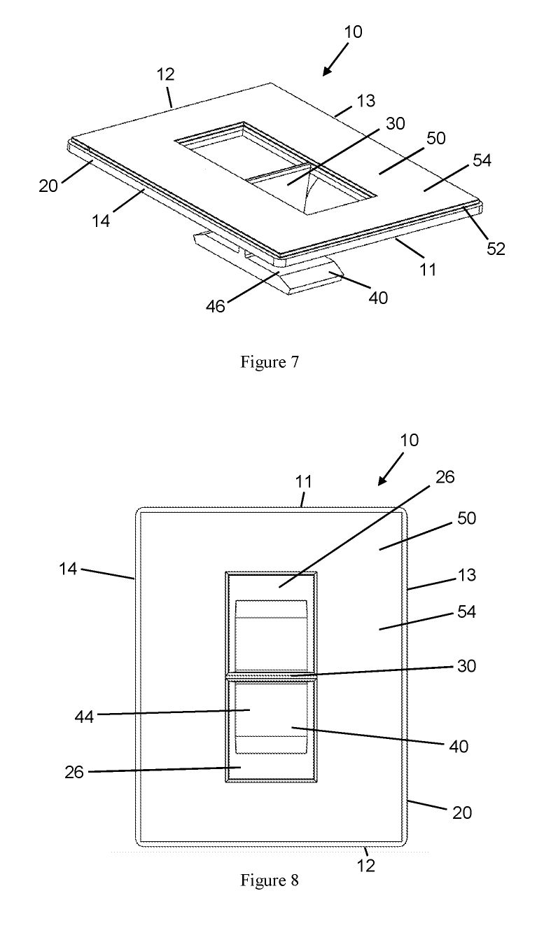

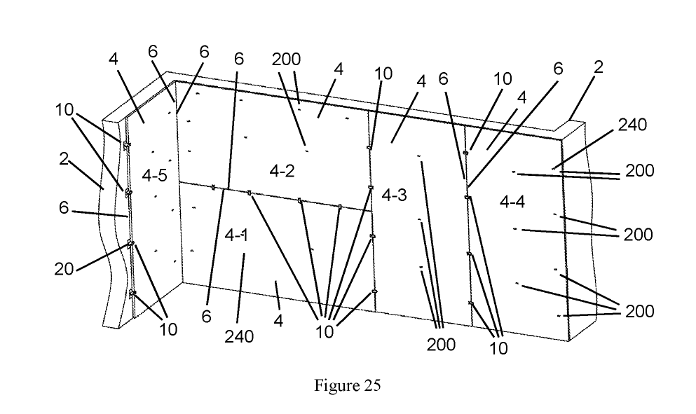

Referring to FIGS. 1-8, a first clip 10 is shown. This clip 10 is also referred to as a “T-Clip.” This clip 10 is sized to be used with sheets of one inch thick insulation sheets and to be used along the sheet edges of two abutting sheets of insulation where the sheets are to be affixed on the same wall face such that the sheets are substantially coplanar. Clip 10 has a base 20, which includes a base front surface 22 and an opposite base rear surface 24. Extending upward and away from the base front surface 22, and generally transverse thereto, is a spacer 30. Spacer 30 has a spacer bottom facing side 32 and an opposed spacer top facing side 34. At the upper end of the spacer 30 is a head 40, which has a laterally extending portion 42. Head 40 also has a head front surface 44 and an opposed head rear surface 46. The head rear surface 46 is generally transverse to spacer 30 and lies in a plane which generally parallel to the base front surface 22. As this clip 10 is sized to receive the edge of a sheet of insulation having a thickness of one inch, the spacer 30 is sized so that the base front surface 22 and the head rear surface 46 are generally an inch apart; for example, from one inch to one and an eighth inch. The base front surface 22, the spacer top facing side 34, and the head rear surface 46 form a top insulation receiving slot 60, while the base front surface 22, the spacer bottom facing side 32, and the head rear surface 46 form a bottom insulation receiving slot 62. With particular reference to FIGS. 7 and 8, clip 10 is shown having two-sided tape 50, with a base rear surface engaging side 52 and a wall engaging side 54, having its base rear surface engaging side 52 adhered to base rear surface 24. Tape 50's wall engaging side 54 will be used to adhere the clip 10 to a desired location on a wall, which will be further explained with the discussion of FIG. 25.

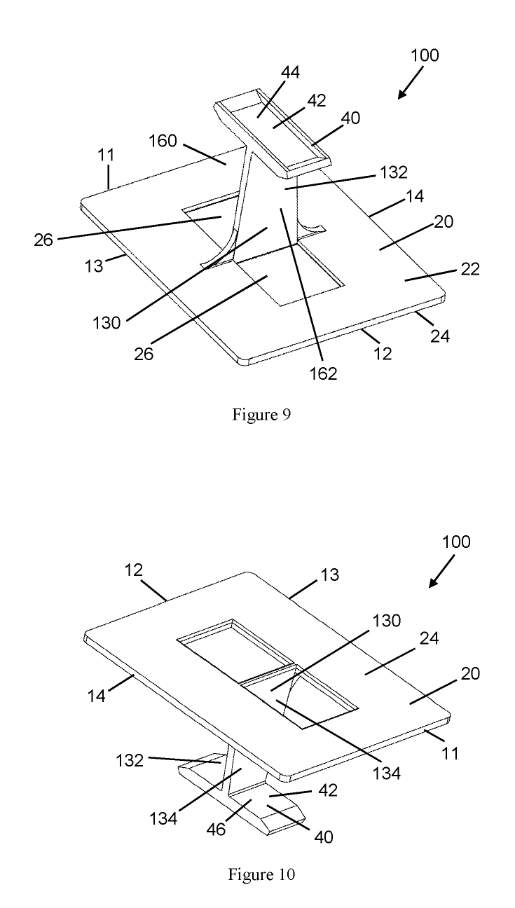

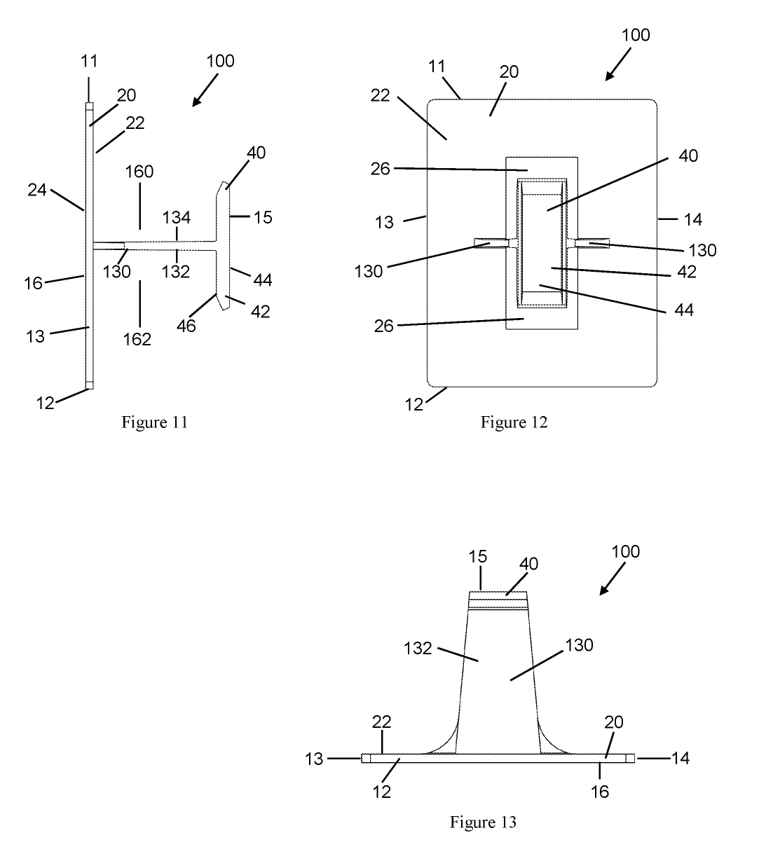

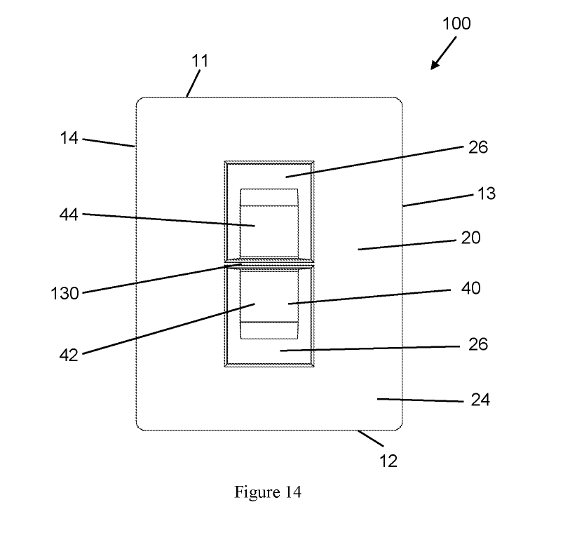

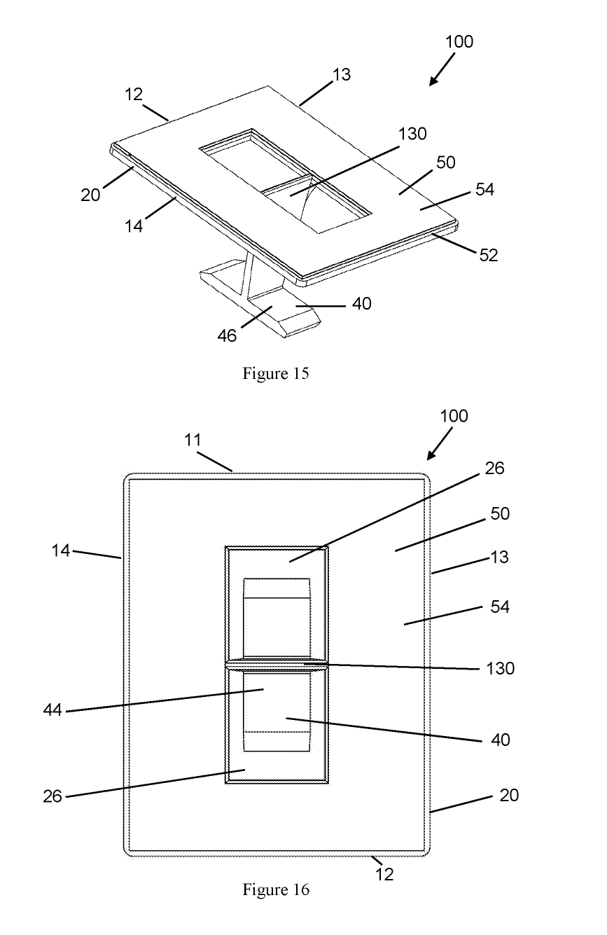

Referring to FIGS. 9-16, a second clip 100 is shown. As with clip 10, this clip 100 is also referred to as a “T-Clip.” This clip 100 is sized to be used with sheets of two inch thick insulation sheets and to be used along the sheet edges of two abutting sheets of insulation where the sheets are to be affixed on the same wall face such that the sheets are substantially coplanar. Clip 100 has a base 20, which, as with clip 10, includes a base front surface 22 and an opposite base rear surface 24. Extending upward and away from the base front surface 22, and generally transverse thereto, is a spacer 130. Spacer 130 has a spacer bottom facing side 132 and an opposed spacer top facing side 134. At the upper end of the spacer 130, as with clip 10, is a head 40, which has a laterally extending portion 42. Head 40 also has a head front surface 44 and an opposed head rear surface 46. The head rear surface 46 is generally transverse to spacer 130 and lies in a plane which generally parallel to the base front surface 22. As this clip 100 is sized to receive the edge of a sheet of insulation having a thickness of two inches, the spacer 130 is sized so that the base front surface 22 and the head rear surface 46 are generally two inches apart; for example, from two inches to two and an eighth inch. The base front surface 22, the spacer top facing side 134, and the head rear surface 46 form a top insulation receiving slot 160, while the base front surface 22, the spacer bottom facing side 132, and the head rear surface 46 form a bottom insulation receiving slot 162. With particular reference to FIGS. 15 and 16, as with clip 10, clip 100 is shown having two-sided tape 50, with a base rear surface engaging side 52 and a wall engaging side 54, having its base rear surface engaging side 52 adhered to base rear surface 24. Tape 50's wall engaging side 54 will be used to adhere the clip 100 to a desired location on a wall, which will be further explained with the discussion of FIG. 25.

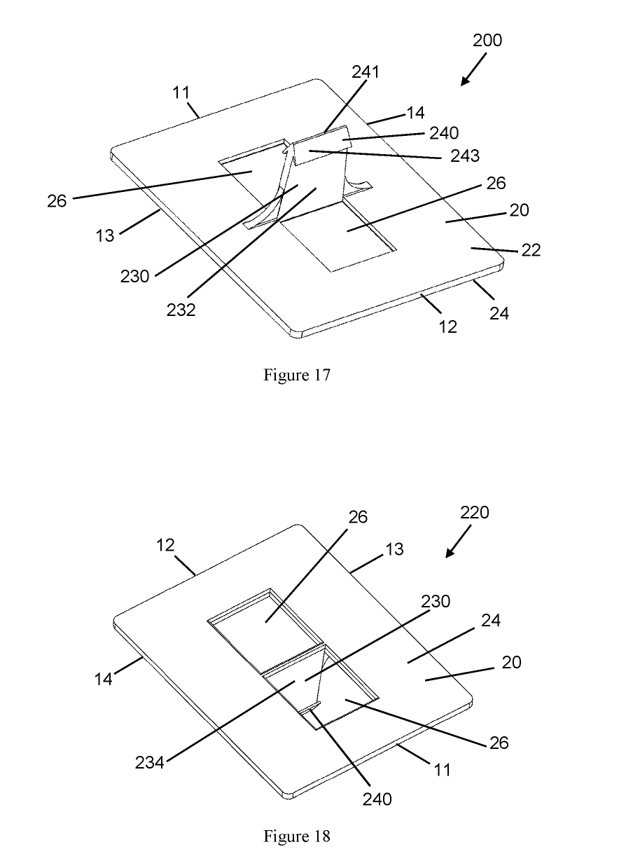

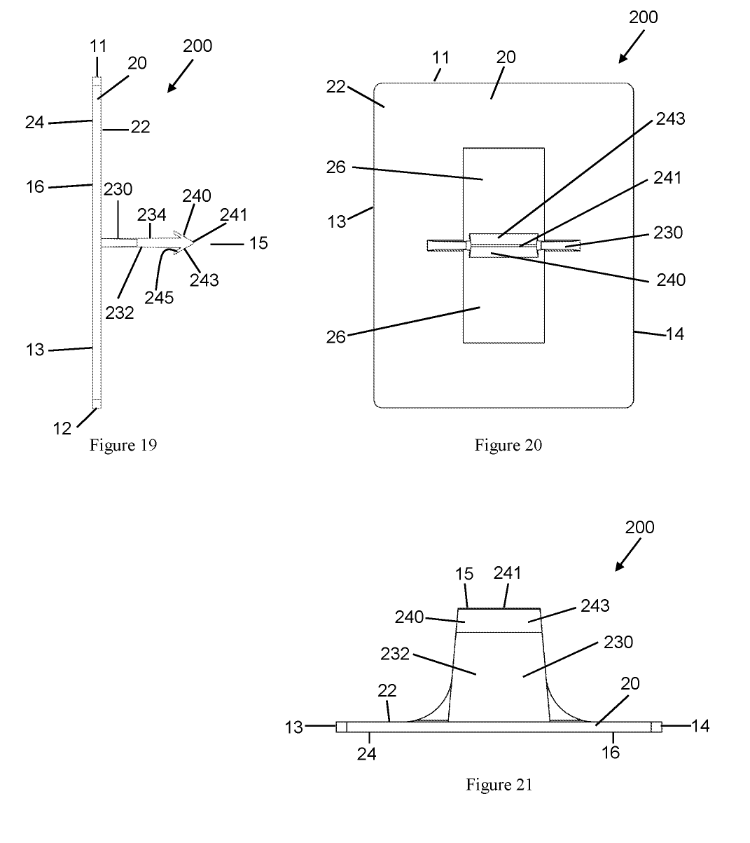

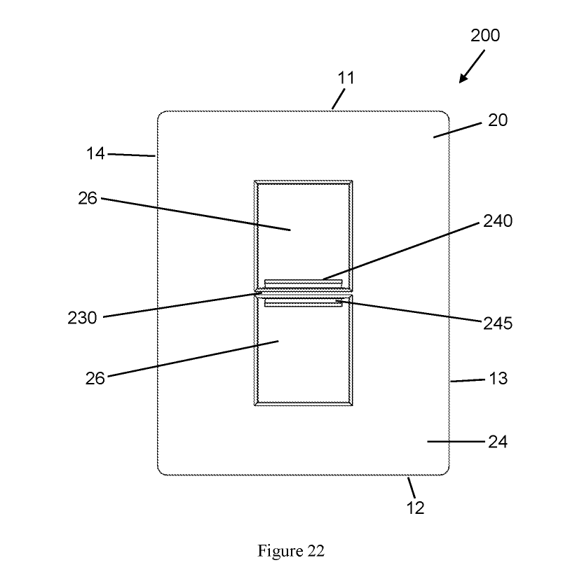

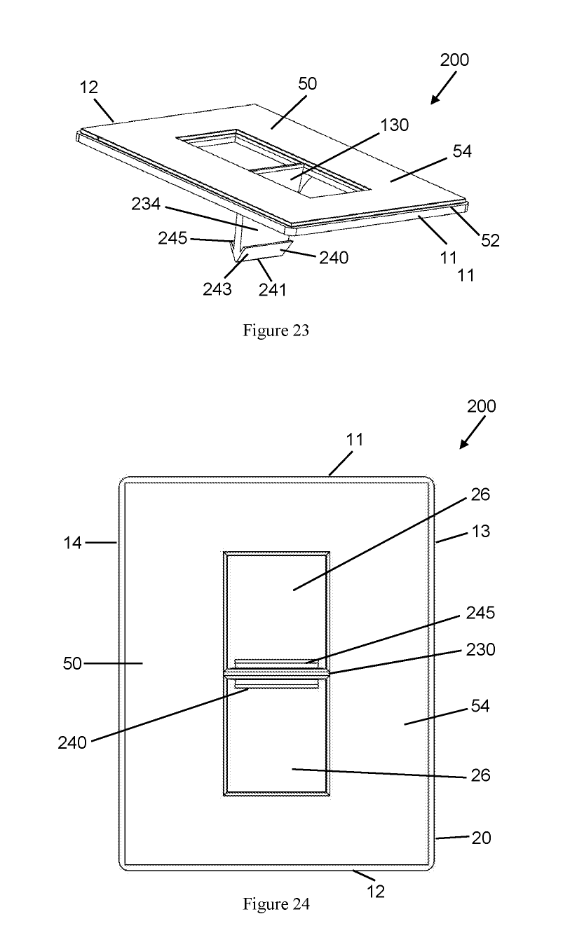

Referring to FIGS. 17-24, a third clip 200 is shown. This clip 200 is referred to as an “A-Clip.” This clip 200 is sized to be used with sheets of either one or two inch thick insulation sheets, or sheets of other thicknesses. Clip 200 has a base 20, which, as with clips 10 and 100, includes a base front surface 22 and an opposite base rear surface 24. Extending upward and away from the base front surface 22, and generally transverse thereto, is a spacer 230. Spacer 230 has a spacer bottom facing side 232 and an opposed spacer top facing side 234. At the upper end of the spacer 230 is a head 240, which has a head front surface 241. Head 240 also has a head rearward sloping surface 243 and a head rear surface 245. In a preferred embodiment, spacer 230 is sized so that the base front surface 22 and the closest part of head 240 thereto are generally at least an inch apart; for example, from one inch to one and an eighth inch. With particular reference to FIG. 19, from the side, head 240 has the shape of an arrow head. Above, it was mentioned that clip 200 can be used with insulation sheets of any thickness. The arrow head shape is preferable so that head 240 can either fully penetrate the thickness of a sheet of insulation having a thickness of an inch or less or be received within a sheet of insulation having a thickness of over an inch and then be resistant to the insulation sheet being removed. With particular reference to FIGS. 23 and 24, as with clips 10 and 100, clip 200 is shown having two-sided tape 50, with a base rear surface engaging side 52 and a wall engaging side 54, having its base rear surface engaging side 52 adhered to base rear surface 24. Tape 50's wall engaging side 54 will be used to adhere the clip 200 to a desired location on a wall, which will be further explained with the discussion of FIG. 25.

Referring to FIG. 25, a portion of a wall 2, sheets of one inch insulation 4, and the edge 6 of a sheet of insulation are shown. Also shown, is the use of a preferred clip system using a plurality of clips 10 and clips 200 to affix sheets of 4 to wall 2. While clips 200 can be used with sheets of any thickness, five one inch sheets 4 are shown in FIG. 25 so that the heads 240 of clips 200 fully penetrate the thickness of the and show in the figure. Where two sheets of insulation 4 will abut along their edges 6 and the sheets will be coplanar, such as along the long wall section receiving four sheets of insulation in FIG. 25, clips 10 are used such that the edge 6 of one sheet of insulation is received in slot 60 and the edge 6 of the abutting sheet of insulation is received in slot 62 of a clip 10. Clips 200 are used internally or near the edges of a sheet of insulation where coplanar sheets do not abut, such as shown by the plurality of clips 200 and their heads 240 appearing in FIG. 25. To start application of sheets 4 to the wall 2 of FIG. 25, as an example, sheet 4-1 can be applied, followed by sheets 4-2, 4-3, 4-4, and 4-5. The number of clips 10 and 200 shown are for example only. Depending on conditions, more or fewer clips 10 and 200 may be used. As was mentioned, this clip system is typically used for affixing insulation to an exterior wall, such as a basement wall, and, subsequent to affixing, back fill will be completed such that the insulation will not be visible. Conditions at the time of affixing, the cleanliness of the wall, whether or not the wall has a waterproof coating applied, weather and temperature, how long it will be before back filling, and other issues can impact how many clips will be used. Starting with sheet 4-1 to be affixed at the bottom left along the long wall shown in FIG. 25, it is preferable that a knife or similar cutting instrument be used to cut slots in or through the insulation sheet at locations where clips 200 will be used. As shown, sheet 4-1 uses 3 clips 200. After the slots are cut, the head 240 of each clip 200 is inserted into a slot and then, using the wall engaging side 54 of two-sided tape 50, sheet 4-1 is affixed to the bottom left of wall 2. As is shown, four clips 10 are then used along the abutting top surface of sheet 4-1 and two clips 10 are used along the right abutting side of sheet 4-1. These clips 10 are located where they are to be attached with either of slot 60 or 62 receiving edge 6 and then the two-sided tape 50 is used to affix each clip 10 to wall 2. Next, sheet 4-2 is to be affixed atop sheet 4-1. Sheet 4-2 is shown with eight clips 200. Slots are cut into sheet 4-2 at the locations for those eight clips 200, and the head 240 of each clip 200 is inserted through a slot. Sheet 4-2 is placed atop sheet 4-1 such that the other of either slot 60 or 62 receives the bottom edge 6 of sheet 4-2 such that sheets 4-1 and 4-2 are in an abutting coplanar relationship and the force is applied to each the clips so the two-sided tape 50 adheres each clip to the wall 2. Then, the right edge 6 of sheet 4-2 is to receive two additional clips 10, which are affixed just as the two clips 10 on the right side of sheet 4-1 were affixed. That leaves four clips 10 along the right sides of sheets 4-1 and 4-2 to receive sheet 4-3. Sheet 4-3 is shown with three clips 200. Slots are cut, heads 240 are inserted, and sheet 4-3 is inserted into slots 60 or 62 of clips 10 on the right sides of sheets 4-1 and 4-2, and pressure is again applied to affix the clips 200 in sheet 4-3 to wall 2. Four clips 10 are now received along the right side of sheet 4-3 and affixed to wall 2. Sheet 4-4 is now ready to be affixed. The left side of sheet 4-4 will abut sheet 4-3, but the other three sides do not abut another sheet along that wall plane. As such, seven clips 200 are used with sheet 4-4. Slots are cut, heads 240 are inserted into the slots, sheet 4-4 is inserted into slots of the clips 10 along the right side of sheet 4-3, and pressure is again applied to affix the clips 200 in sheet 4-4 to wall 2. While sheet 4-5 will abut sheets 4-1 and 4-2, it is not coplanar therewith. As such, clips 10 are not used along the abutting edges. As is shown, sheet 4-5 uses seven clips 200. Slots are cut, heads 240 are inserted into the slots, and sheet 4-5 is positioned such that its right edge abuts the left edges of sheets 4-1 and 4-2 and pressure is applied to clips 200 to affix them to wall 2. Wall 2 is shown continuing in a plane beyond the left edge of sheet 4-5. As such, four clips 10 have been affixed along the left edge of sheet 4-5 such that additional sheets 4 can be applied along wall 2 using clips 10 or 200, as appropriate. If the insulation being applied was two inch thick insulation, clips 200 would still be used, but head 240 would not be seen as are seen in FIG. 25 unless the length of spacer 230 was increased. However, with the arrow head shape, the inventors do not believe this necessary as the arrow head shape helps retain the head 240 in its cut slot in sheet 4. However, with two inch thick, clips 100 instead of clips 10 would be used along abutting edges of coplanar sheets.

The foregoing detailed description is given primarily for clearness of understanding and no unnecessary limitations are to be understood therefrom, for modifications can be made by those skilled in the art upon reading this disclosure and may be made without departing from the spirit of the invention. Although specific spatial dimensions are stated herein, such specific quantities are presented as examples only.

1. A clip system for affixing foam insulation to a wall, the clip system comprising:
a. at least one T-clip, said T-clip having a base with a base front surface and an opposed base rear surface; a spacer extending from said base, away from said base front surface and generally transverse thereto, said spacer having a bottom facing side and an opposed top facing side, said spacer terminating in a head opposed from said base, said head having a laterally extending portion with a head front surface and a head rear surface, where said head rear surface is in a parallel relationship with said base front surface; and,
b. at least one A-clip, said A-clip having a base with a base front surface and an opposed base rear surface; a spacer extending from said base, away from said base front surface and generally transverse thereto, said spacer having a bottom facing side and an opposed top facing side, said spacer terminating in a head opposed from said base, said head having a head front surface with a rearward sloping surface and an underneath rear surface.

2. The clip system of claim 1, where said T-clip head rear surface, said spacer bottom facing side, and said base form a bottom insulation receiving slot and where said T-clip head rear surface, said spacer top facing side, and said base form a top insulation receiving slot.

3. The clip system of claim 1, where said T-clip head rear surface is spaced at least one inch away from said base front surface.

4. The clip system of claim 1, where said T-clip head rear surface is spaced at least two inches away from said base front surface.

5. The clip system of claim 1, where said A-clip head has a generally arrow head shaped cross section.

6. The clip system of claim 1, where said A-clip spacer removes said head from said base a distance of at least one inch.

7. The clip system of claim 1, where each of said at least one T-clip and said at least one A-clip have a two-sided tape attached to their base rear surface.

8. A clip for affixing foam insulation to a wall, comprising: a base with a base front surface and an opposed base rear surface; a spacer extending from said base, away from said base front surface and generally transverse thereto, said spacer having a bottom facing side and an opposed top facing side, said spacer receiving a head thereon opposed from said base; wherein the base includes an opening adjacent to said spacer.

9. The clip of claim 8, said head having a laterally extending portion with a head front surface and a head rear surface, where said head rear surface is in a parallel relationship with said base front surface.

10. The clip of claim 9, where said head rear surface, said spacer bottom facing side, and said base form a bottom insulation receiving slot and where said head rear surface, said spacer top facing side, and said base form a top insulation receiving slot.

11. The clip of claim 9, where said head rear surface is spaced at least one inch away from said base front surface.

12. The clip of claim 9, where said head rear surface is spaced at least two inches away from said base front surface.

13. The clip of claim 9, where a two-sided tape is attached to said base rear surface.

14. The clip of claim 8, said head having a head front surface with a rearward sloping surface and an underneath rear surface.

15. The clip of claim 14, where said head has a generally arrow head shaped cross section.

16. The clip of claim 14, where said spacer removes said head from said base a distance of at least one inch.

17. The clip of claim 14, where a two-sided tape is attached to said base rear surface.
